(19) United States
(12) Patent Application Publication
(10) Pub. No.: US 2021/0337422 A1
(43) Pub. Date: Oct. 28, 2021

(54) QCI Based Traffic-Offload of PDN Traffic at Trusted Wifi Access Gateway

(71) Applicant: Parallel Wireless, Inc., Nashua, NH (US)

(72) Inventors: Balaji Jeyabalan, Karnataka (IN); Sankara Subramaniam B S, Karnataka (IN)

(21) Appl. No.: 17/241,052

(22) Filed: Apr. 26, 2021

Related U.S. Application Data
(60) Provisional application No. 63/015,282, filed on Apr. 24, 2020.

(51) Int. Cl. H04W 28/02; H04W 76/12

(52) U.S. Cl. CPC H04W 28/0268; H04W 84/12; H04W 76/12

(57) ABSTRACT

A method, system and compute readable media for Quality of Service (QoS) Class Identifier (QCI) based traffic-offload of Packet Data Network (PDN) traffic at a trusted Wireless Fidelity (WiFi) access gateway are presented. In one embodiment a method includes for an initial attachment of a User Equipment (UE) via a Trusted Wireless Access Network (TWAN): providing TWAN the QCI value in an Attribute Value Pair (AVP) in an Access point Network (APN)-Configuration AVP; using by a Trusted Wireless Access Gateway (TWAG) a QoS profile while requesting for default bearer creation with Packet Data Network Gateway (PGW) using General Packet Radio Service Tunneling Protocol (GTP)V2 Create Session Request; responding, by the PGW, with a final QoS profile based on various parameters; and making a determination if the QCI equals a QCI offload (QCIo) and routing traffic in accordance with the determination.

### CROSS-REFEREMCE TO RELATED APPLICATIONS

This application claims priority under 35 U.S.C. § 119(e) to U.S. Provisional Pat. App. No. 63/015,282, filed Apr. 24, 2020, titled “QCI Based Traffic-Offload of PDN Traffic at Trusted Wifi Access Gateway” which is hereby incorporated by reference in its entirety for all purposes. The present application hereby incorporates by reference U.S. Pat. App. Pub. Nos. US20110044285, US20140241316; WO Pat. App. Pub. No. W02013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850U501); US20170272330A1 (PWS-71850U502); and 15/713,584 (PWS-71850U503). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

Currently, all the Subscriber (UE) traffic via TWAG must be tunneled to PGW from where it is sent to the external IP world/destination network. If the operator could provision the destination-network reachability from TWAG itself then the traffic need not go through one tunneled extra-hop (PGW) before reaching the destination network.

The existing methods to support the above scenario are listed below:

TWAG skips any signaling on the S2a interface. Instead, it provides IP to the Subscriber on its own from a local IP Pool. And, also, takes care of the NAT-ing of the traffic towards the external Internet world.

The UE's IP address is allocated by the external P-GW. However, TWAG applies Layer 4 rules to the data traffic using locally configured Access Control Lists (ACLs) to determine the part of traffic to be offloaded directly through NAT-ing instead of sending it to the P-GW. The rest of the traffic flows in GTP tunnel via the PGW.

While both the above methods offer an offloading solution to the UE traffic, the offload is not controlled by the PGW. They are more of a standalone decision of TWAG (with/without AAA's knowledge) without the consent or the knowledge of PGW.

### SUMMARY

A method of offloading the PDN traffic from TWAG using a unique QoS Class Identifier (QCI) supplied by 3GPP PDN Gateway (PGW) during Creation or Update of a Bearer thereby skipping the tunneling of the traffic towards PGW is disclosed. Please note that the term OFFLOAD generally refers to the mobile traffic offload to WLAN(WiFi) access to avert the spectrum cost/unavailability. However the traffic-offload we are discussing in this document refers to the part(or complete) traffic getting offloaded from TWAN.As we are nearing 2020, the standards for 5G are being finalized. 5G, the 3GPP version of ITU IMT-2020 is the main and only contender for the next generation of mobile technology. What is obvious to everyone is that 5G will be a natural evolution from 4G and will drive the ecosystem innovation to deliver enhanced customer experience while extending 4G network investments.

A method for Quality of Service (QOS) Class Identifier (QCI) based traffic-offload of Packet Data Network (PDN) traffic at trusted Wireless Fidelity (WiFi) access gateway is presented. In one embodiment, the method includes for an initial attachment of a User Equipment (UE) via Trusted Wireless Access Network (TWAN): providing TWAN the QCI value in an Attribute Value Pair (AVP) in an Access point Network (APN)-Configuration AVP; using by a Trusted Wireless Access Gateway (TWAG) a QOS profile while requesting for default bearer creation with packet Data Network Gateway (PGW) using General Packet Radio Service Tunneling Protocol (GTP)V2 Create Session Request; responding, by the PGW, with a final QOS profile based on various parameters; and routing by the TWAG, when the QCI equals a QCI Offload (QCIo), all the default bearer traffic directly Network Access Translation (NAT)-ed to an external network.

In another embodiment a system for Quality of Service (QoS) Class Identifier (QCI) based traffic-offload of Packet Data Network (PDN) traffic at a trusted Wireless Fidelity (WiFi) access gateway, includes a WiFi device; an Access Point (AP) in wireless communication with the WiFi device; a Trusted Wireless Access Gateway (TWAG) in communication with the AP, the TWAG including a first Network Address Translation (NAT) element; a General Packet Radio Service Tunneling Protocol (GTP) tunnel in communication with the TWAG; a Packet Data Network Gateway (PGW) in communication with the GTP tunnel, the PGW including a second NAT element; an external network in communication with the PGW and the TWAG; and wherein the system, for an initial attachment of a User Equipment (UE) via a Trusted Wireless Access Network (TWAN): provides TWAN the QCI value in an Attribute Value Pair (AVP) in an Access Point Network (APN)-Configuration AVP; uses by a Trusted Wireless Access Gateway (TWAG) a QoS profile while requesting for default bearer creation with packet Data Network Gateway (PGW) using General Packet Radio Service Tunneling Protocol (GTP)V2 Create Session Request; responds, by the PGW, with a final QoS profile based on various parameters; and makes a determination if the QCI equals a QCI offload (QCIo) and routing traffic in accordance with the determination.

In another embodiment a non-transitory computer-readable medium containing instructions for Quality of Service (QoS) Class Identifier (QCI) based traffic-offload of Packet Data Network (PDN) traffic at a trusted Wireless Fidelity (WiFi) access gateway which, when executed, cause a system to perform steps comprising: for an initial attachment of a User Equipment (UE) via a Trusted Wireless Access Network (TWAN): providing TWAN the QCI value in an Attribute Value Pair (AVP) in an Access point Network (APN)-Configuration AVP; using by a Trusted Wireless Access Gateway (TWAG) a QoS profile while requesting for default bearer creation with packet Data Network Gateway (PGW) using General Packet Radio Service Tunneling Protocol (GTP)V2 Create Session Request; responding, by the PGW, with a final QoS profile based on various parameters; and making a determination if the QCI equals a QCI offload (QCIo) and routing traffic in accordance with the determination.

### BRIEF DESCRIPTION OF THE DRAWINGS

FIG. 1 is a diagram showing a call flow for an initial attach of UE via TWAN over S2a, in accordance with some embodiments.

FIG. 2 is a diagram showing a call flow where a PGW sends Create Bearer Request with a standardized QCI value and the respective QOS channel, in accordance with some embodiments.

FIG. 3 is a diagram showing a system for QCI based traffic-offload of PDN traffic at a trusted Wifi access gateway , in accordance with some embodiments.

FIG. 4 is a diagram showing a call flow where QCIo is the Bearer QOS's QCI which is exclusively assigned by the network for Offloading the corresponding bearer's traffic directly from TWAG, in accordance with some embodiments.

FIG. 5 is a schematic network architecture diagram for various radio access technology core networks.

FIG. 6 is an enhanced eNodeB for performing the methods described herein, in accordance with some embodiments.

FIG. 7 is a coordinating server for providing services and performing methods as described herein, in accordance with some embodiments.

### DETAILED DESCRIPTION

TWAG uses the standard S2a interface to connect to the PGW. The dedicated bearer Activation/Modification on S2a uses the below call flow:

Step1: Initial Attach of UE via TWAN Over S2a.

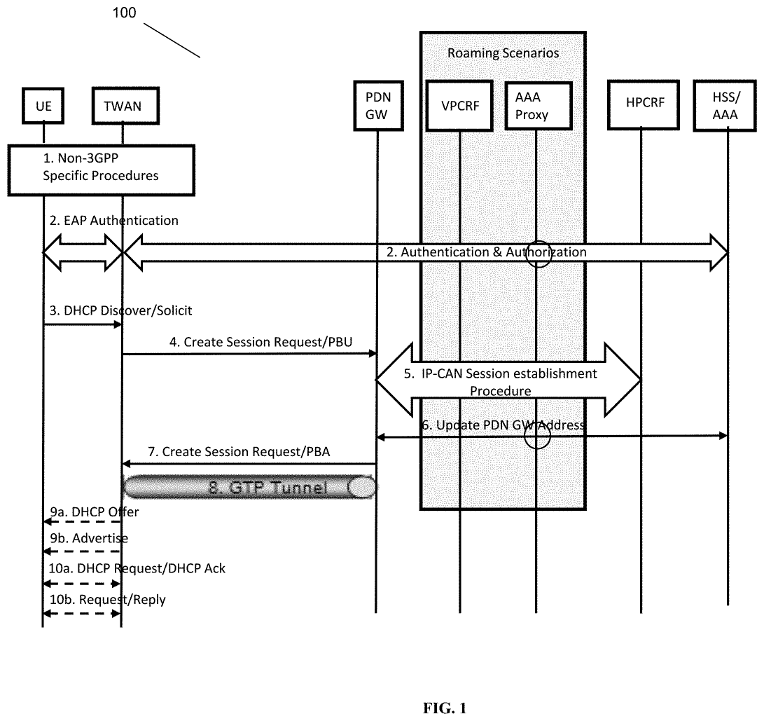

As seen in the call flow diagram 100 of FIG. 1, post the EAP authentication and authorization with 3GPP HSS/AAA, TWAN sends a GTPV2 CREATE SESSION REQUEST towards PDN GW. PDN GW responds post the consultations on the Policy and charging front, with a CREATE SESSION RESPONSE. This includes the EPS bearer ID which is usually the default bearer for the UE, along with the UE's IP address and other information necessary for a successful PDN connectivity for the UE via TWAG further tunneled in GTP towards PDN GW.

UE is provided the PDN IP and all of its traffic that reaches TWAG is sent towards PGW inside GTP Tunnel

Step2: Dedicated Bearer Activation with GTP on S2a.

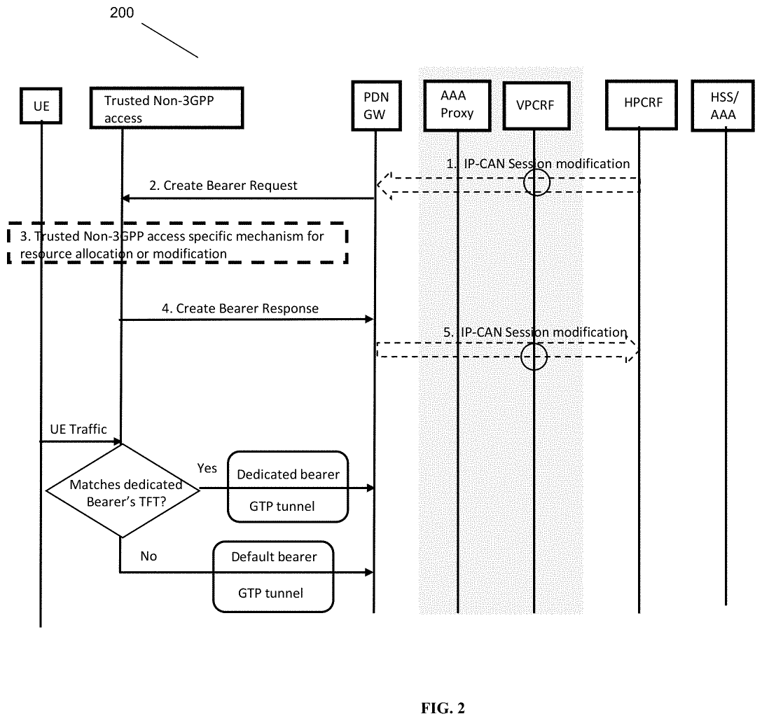

The call flow diagram 200 of FIG. 2, the PGW sends Create Bearer Request with a standardized QCI value and the respective QOS. It also contains a Bearer TFT containing certain Uplink and Downlink Traffic Flow templates that the traffic has to satisfy to be considered for this bearer.

TWAG installs the TFT check in its Traffic flow and sends Create Bearer Response with a Bearer ID.

The above two messages communicate their respective Source S2a GTPU Tunnel Endpoint IDs (TEID) to each other, which is used to tunnel further UE traffic from each other which matches the bearer's TFT.

The UE traffic not matching the dedicated bearer's TFT would continue taking the Default Bearer's tunnel.

If we could provide a solution to offload traffic from TWAN with PGW still controlling that decision would help operators life easier to have single point of policy/control.

This proposed solution in TWAN helps achieving this idea for the mobile-subscribers traffic-offload from TWAN with the consent of PGW.

Every EPS Bearer created will have a corresponding Quality of Service (QoS), which includes a byte long Quality Class Identifier (QCI) value. 3GPP specification TS23.401 has defined some standard QCI values up to 85 (0x55). The remaining reserved QCI values (86-254) are not defined and is up to the operator to make use of them for any differentiated service.

Our proposed idea is to make use of one or more QCI value from the reserved QCI, i.e., 86 to 254, to enforce traffic offload from TWAN instead of tunneling them to the PGW. These reserved QCI values are collectively referred to as QCIo (o indicating Offload) in the rest of the document for convenience. Please note that this QCIo should be known across TWAN and PGW for Offload to work with controlled Quality-Of-Service on data traffic.

This way, QCIo acts as decision making criteria for the TWAG to offload the traffic making this solution PGW aware and easy to manage from single policy-server (or PGW). The QCIo can be passed during bearer creation or modification by PGW. Then TWAN directly NATs the corresponding UE bearer traffic to the external IP world and also apply the DSCP marking to have a controlled QoS handling in the offloaded data traffic.

This method would be applicable (and not restricted) to these areas:

Initial Attachment of UE via TWAN:

During Authorization phase of the Attach, 3GPP AAA/HSS provides TWAN the QCI value in EPS-Subscribed-QOS-Profile AVP in APN-Configuration AVP.

TWAG uses this QOS Profile while requesting for Default Bearer Creation with PGW using GTPV2 Create Session Request and the PGW will respond with the final QOS Profile based on various parameters like policy/apn etc.

If this QCI=QCIo, then TWAG would route all the Default Bearer Traffic directly NAT-ed to the external Internet world.

Dedicated Bearer Creation by PGW:

In GTPV2 Create Bearer Request from PGW, the Bearer QOS contains the QCI value. If that QCI=QCIo, then TWAG would route all the traffic of that bearer directly NAT-ed to the external Internet World.

HSS/PGW initiated Bearer QOS Modification:

In both HSS and PGW initiated Bearer QOS Modification, if the resultant QCI is QCIo, then TWAG would route all the traffic of that bearer directly NAT-ed to the external Internet World.

In all the above three cases the offloaded traffic will be marked with the corresponding DSCP value to have controlled traffic-flow in the offloaded network.

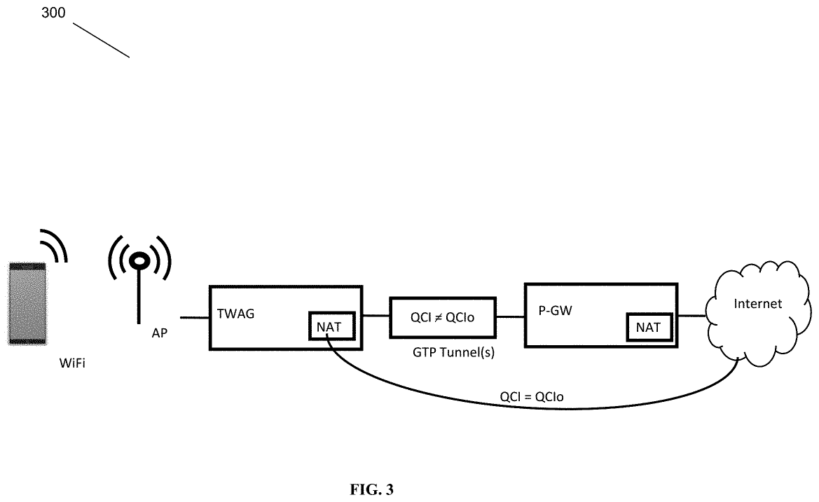

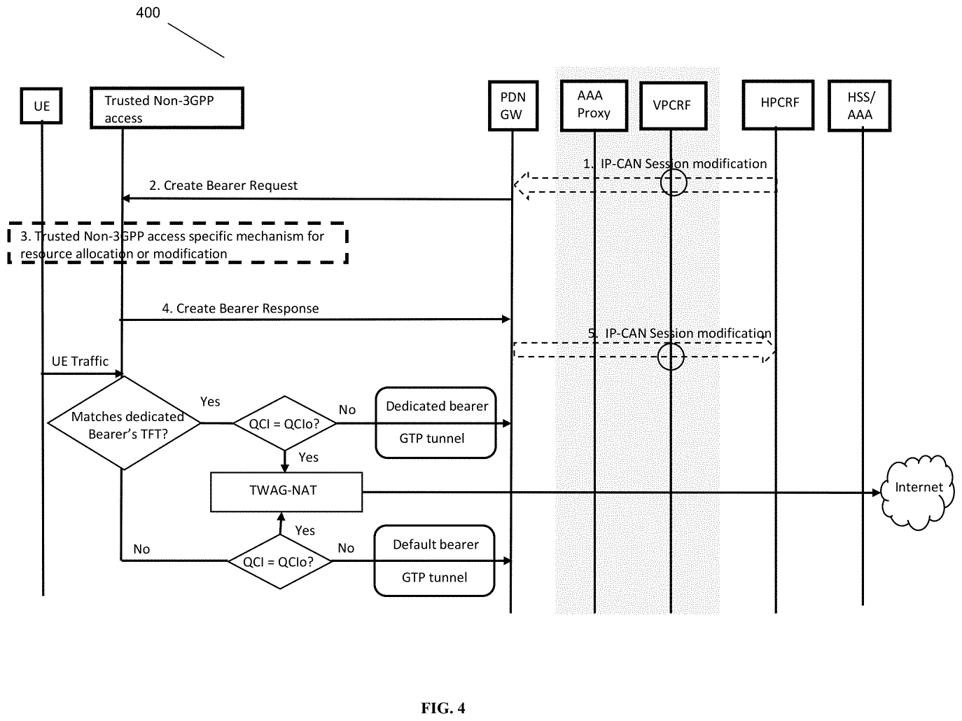

Referring to the block diagram 300 of FIG. 3 and the call flow diagram of FIG. 4, QCIo is the Bearer QOS's QCI which is exclusively assigned by the network for Offloading the corresponding bearer's traffic directly from TWAG. One or more QCI values may be reserved by the network operator for the purpose of traffic offload from TWAG, in some embodiments.

The present disclosure thus provides systems and method for end-to-end PGW-controlled offload (including DSCP marking and TFT classification for the offload traffic together). With this solution, traffic offloaded from the TWAG is still controlled in part or completely by the PGW (or policy server, e.g., PCEF), without requiring a policy enforcement implementation in the TWAG itself. Further, with the advent of QoS support in WLAN 802.11ax (Wi-Fi 6), this QCI may be extended via the WLAN access network to UE to provide end-to-end QoS solution from PGW.

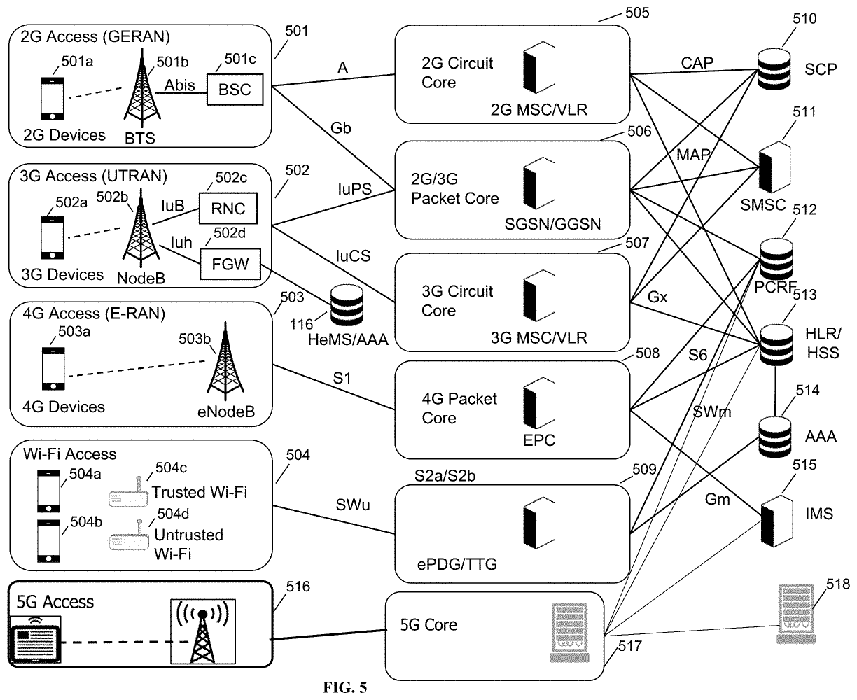

FIG. 5 is a schematic network architecture diagram for 3G and other-G prior art networks. The diagram shows a plurality of “Gs,” including 2G, 3G, 4G, 5G and Wi-Fi. 2G is represented by GERAN 801, which includes a 2G device 701a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point gateway (e.g., TWAG) 504c and an untrusted Wi-Fi access point gateway (e.g., ePDG) 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC), which includes a PGW as described herein, as well as an MME and an SGW; and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

With respect to the present disclosure, although a PGW and a 4G core is principally discussed, the inventors have recognized that the same principles apply for both core networks of other G's (for example, 3G or 5G) interworked to 4G, or for the use of other RAN technologies in cooperation with a 4G core (for example, using interworking to 4G). FIG. 5 shows the use of a 5G Core 517, but the present disclosure may be used for deployments of 5G RAN with or without 5G core (e.g., standalone or non-standalone), and, the present disclosure contemplates the use of the present systems and methods for at least a 5G RAN used with a 4G core.

With respect to the present disclosure, both the TWAG and ePDG are capable of providing offload, and it is understood therefore that where appropriate, the disclosure herein, including pertinent signaling etc., may be adapted to provide equivalent functionality at the ePDG to, e.g., coordinate between an ePDG and a PGW (or other core network node) to provide the functionality and advantages described herein. Where offload is described herein, it is understood that the inventors have contemplated the use of this term to encompass, where appropriate, equivalent technologies such as local IP access (LIPA), local breakout (LBO), etc. As well, where appropriate, IP traffic may be offloaded at any node in the network with an appropriate security gateway functionality.

With respect to the present disclosure, the TWAG, PGW, etc. may be virtualized and all or part of the components shown in FIG. 5 may be implemented using virtual machines, containers, serverless microservices, or other such technologies. In some embodiments one hardware device may provide one or more of the core network nodes shown. In some embodiments the RAN nodes may be designed with a functional split wherein certain functions are performed at a virtual machine, container, server, or other device physically separate from the radio access device or radio head (e.g., according to the Option 6, 7, 8, etc. 3GPP functional splits). In some embodiments, a single UE may have a connection to a plurality of RATs, including Wi-Fi via a TWAG or other security gateway as described in further detail herein.

With respect to the present disclosure, network slicing as discussed and described with regard to 5G may be applied to the 4G technologies described herein. A network slicing slice pairing function may create slices (designated nodes in the network or portions thereof) that are dedicated to one or more UEs or to one or more QoS requirements, and, may use the techniques and methods described herein, including appropriate QCI parameters, to separate out traffic as designated for a particular network slice. The inventors have understood that network parameters evolve over time and intend the present disclosure to provide the functionality described herein even for future versions of, e.g., QCI, GTP, etc.

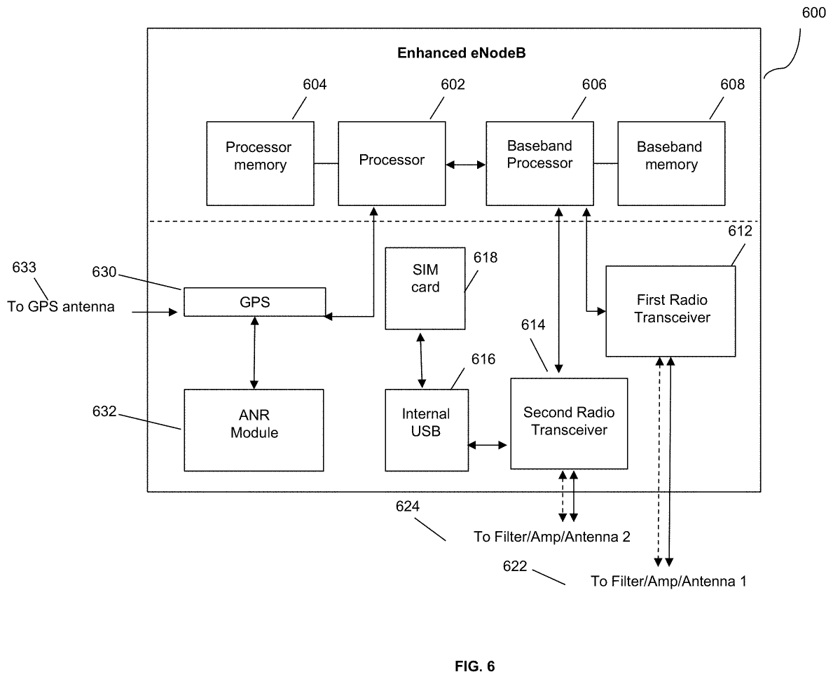

FIG. 6 is an enhanced base station for performing the methods described herein, in accordance with some embodiments. Base station 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be 3G, 4G, 5G, Wi-Fi 602.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

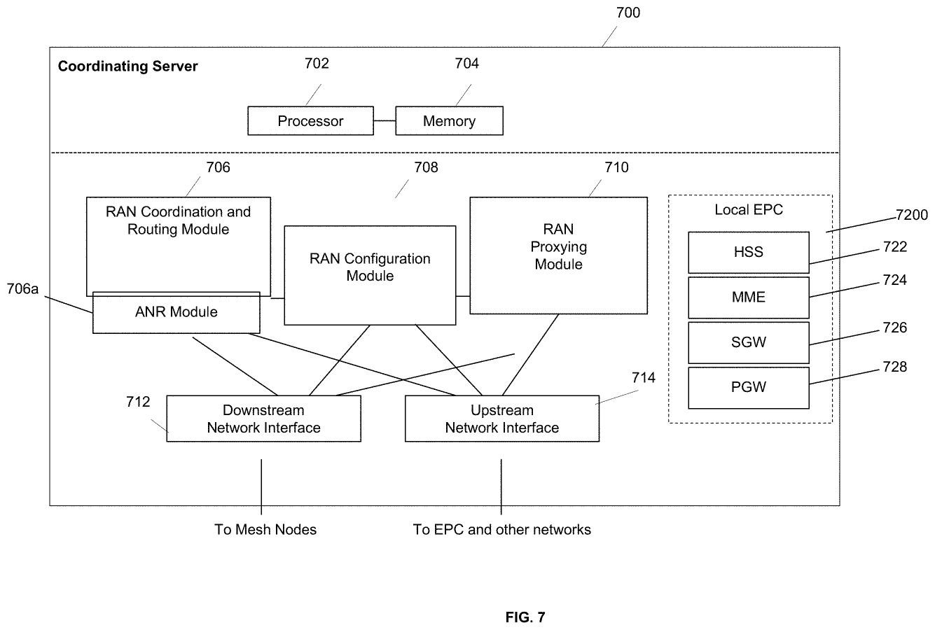

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for Quality of Service (QoS) Class Identifier (QCI) based traffic-offload of Packet Data Network (PDN) traffic at a trusted Wireless Fidelity (WiFi) access gateway, comprising:
for an initial attachment of a User Equipment (UE) via a Trusted Wireless Access Network (TWAN):
providing TWAN the QCI value in an Attribute Value Pair (AVP) in an Access point Network (APN)-Configuration AVP;
using by a Trusted Wireless Access Gateway (TWAG) a QoS profile while requesting for default bearer creation with Packet Data Network Gateway (PGW) using General Packet Radio Service Tunneling Protocol (GTP)V2 Create Session Request;
responding, by the PGW, with a final QoS profile based on various parameters; and
making a determination if the QCI equals a QCI offload (QCIo) and routing traffic in accordance with the determination.

2. The method of claim 1 wherein when the determination is that QCI equals QCIo then routing by the TWAG, all the default bearer traffic directly Network Access Translation (NAT)-ed to an external network.

3. The method of claim 1 wherein when the determination is that QCI equals QCIo then routing by the TWAG, when UE matches dedicated bearer TFT, all the default bearer traffic to a dedicated bearer GTP tunnel.

4. The method of claim 1 wherein when the determination is that QCI equals QCIo then routing by the TWAG, when UE does not match dedicated bearer Traffic Flow Template (TFT), all the default bearer traffic to a default bearer GTP tunnel.

5. The method of claim 1 wherein a bearer QOS contains the QCI value.

6. The method of claim 1 further comprising marking the offloaded traffic with the corresponding Differentiated Services (DiffServ) code points (DSCPs) value to have controlled traffic-flow in an offloaded network.

7. A system for Quality of Service (QoS) Class Identifier (QCI) based traffic-offload of Packet Data Network (PDN) traffic at a trusted Wireless Fidelity (WiFi) access gateway, comprising:
a WiFi device;
an Access Point (AP) in wireless communication with the WiFi device;
a Trusted Wireless Access Gateway (TWAG) in communication with the AP, the TWAG including a first Network Address Translation (NAT) element;
a General Packet Radio Service Tunneling Protocol (GTP) tunnel in communication with the TWAG;
a Packet Data Network Gateway (PGW) in communication with the GTP tunnel, the PGW including a second NAT element;
an external network in communication with the PGW and the TWAG; and
wherein the system, for an initial attachment of a User Equipment (UE) via a Trusted Wireless Access Network (TWAN):
provides TWAN the QCI value in an Attribute Value Pair (AVP) in an Access Point Network (APN)-Configuration AVP;
uses by a Trusted Wireless Access Gateway (TWAG) a QoS profile while requesting for default bearer creation with packet Data Network Gateway (PGW) using General Packet Radio Service Tunneling Protocol (GTP)V2 Create Session Request;
responds, by the PGW, with a final QoS profile based on various parameters; and
makes a determination if the QCI equals a QCI offload (QCIo) and routing traffic in accordance with the determination.

8. The system of claim 7 wherein when the determination is that QCI equals QCIo then routing by the TWAG, all the default bearer traffic directly Network Access Translation (NAT)-ed to an external network.

9. The system of claim 7 wherein when the determination is that QCI equals QCIo then routing by the TWAG, when UE matches dedicated bearer TFT, all the default bearer traffic to a dedicated bearer GTP tunnel.

10. The system of claim 7 wherein when the determination is that QCI equals QCIo then routing by the TWAG, when UE does not match dedicated bearer Traffic Flow Template (TFT), all the default bearer traffic to a default bearer GTP tunnel.

11. The system of claim 7 wherein a bearer QOS contains the QCI value.

12. The system of claim 7 further comprising marking the offloaded traffic with the corresponding Differentiated Services (DiffServ) code points (DSCPs) value to have controlled traffic-flow in an offloaded network.

13. A non-transitory computer-readable medium containing instructions for Quality of Service (QoS) Class Identifier (QCI) based traffic-offload of Packet Data Network (PDN) traffic at a trusted Wireless Fidelity (WiFi) access gateway which, when executed, cause a system to perform steps comprising:
for an initial attachment of a User Equipment (UE) via a Trusted Wireless Access Network (TWAN):
providing TWAN the QCI value in an Attribute Value Pair (AVP) in an Access point Network (APN)-Configuration AVP;
using by a Trusted Wireless Access Gateway (TWAG) a QoS profile while requesting for default bearer creation with packet Data Network Gateway (PGW) using General Packet Radio Service Tunneling Protocol (GTP)V2 Create Session Request;
responding, by the PGW, with a final QoS profile based on various parameters; and
making a determination if the QCI equals a QCI offload (QCIo) and routing traffic in accordance with the determination.

14. The computer-readable medium of claim 13 further comprising instructions wherein when the determination is that QCI equals QCIo then routing by the TWAG, all the default bearer traffic directly Network Access Translation (NAT)-ed to an external network.

15. The computer-readable medium of claim 13 further comprising instructions wherein when the determination is that QCI equals QCIo then routing by the TWAG, when UE matches dedicated bearer TFT, all the default bearer traffic to a dedicated bearer GTP tunnel.

16. The computer-readable medium of claim 13 further comprising instructions wherein when the determination is that QCI equals QCIo then routing by the TWAG, when UE does not match dedicated bearer Traffic Flow Template (TFT), all the default bearer traffic to a default bearer GTP tunnel.

17. The computer-readable medium of claim 13 further comprising instructions wherein a bearer QOS contains the QCI value.

18. The computer-readable medium of claim 13 further comprising instructions marking the offloaded traffic with the corresponding Differentiated Services (DiffServ) code points (DSCPs) value to have controlled traffic-flow in an offloaded network.
